(19) United States
(12) Patent Application Publication
(10) Pub. No.: US 2006/0216425 A1
(43) Pub. Date: Sep. 28, 2006

(54) Process for chemically aging certain wood species

(75) Inventors: Richard W. Neelley, Magnolia, TX (US); Richard Miller, Simpsonsville, SC (US)

Correspondence Address: MARY J. GASKIN;ANNELIN & GASKIN, 2170 BUCKTHORNE PL., SUITE 220, THE WOODLANDS, TX, 77380, US

(73) Assignee: Eco Building Systems, L.P.

(21) Appl. No.: 11/088,091

(22) Filed: Mar. 23, 2005

(51) Int. Cl. B05D 3/02

(52) U.S. Cl. 427/397; 427/299

(57) ABSTRACT

A process for accelerating the natural aging and darkening of certain reddish-brown tropical wood products. The process uses a chemical solution of potassium dichromate in isopropyl alcohol, which is applied to the surfaces of the wood products. After the chemical reaction has occurred the wood is dried. The resulting wood color is both stable and permanent.

### BACKGROUND OF THE INVENTION

Certain tropical wood species are naturally red or reddish-brown in color, tending to become darker in appearance when exposed to sunlight and other ultraviolet light, or when subjected to other conditions causing oxidation. As a result, in order to preserve the original appearance and color of such wood species, various finishes have been developed and produced, typically combining ultraviolet/light ray inhibitors and anti-fading agents. While many of these products provide some protection from the effects of exposure to ultraviolet rays, no finish presently available is completely effective in preventing tropical wood species from aging or darkening over the passage of time.

Some presently-available wood treatments use a different approach. Wood stains and other topical applications, formulated with reddish colors, have been applied to the surfaces of wood products in orderto simulate natural aging and darkening. However, after prolonged exposure to ultraviolet light rays and oxidants, the color of such stains tends to lighten and fade. Presently, no known process exists which accelerates the natural aging and darkening of certain wood species, resulting in a color which is both stable and permanent.

### SUMMARY OF THE INVENTION

The present invention is a chemical aging process for use on reddish-brown tropical woods used in flooring, paneling, molding, furniture, and other interior structures. The process uses no dyes or stains. Instead, the transparent chemical solution, which is applied to certain tropical wood products, reacts with natural oils and resins, such as lignin, in the wood structure. The color in the wood cells visibly darkens and becomes permanently set. The result is a finished product with a consistent, enriched, and blended color, which will not darken further over time. The chemical solution contains no volatile organic compounds (VOC's), yet raises the pH of the wood, thereby inhibiting decay, mold, and bacterial growth. Optionally, after the wood is dry, the surface of the wood product can be coated with a layer of ultraviolet acrylic in order to reduce fading, wear, stains, and microbial growth.

It is an object of the present invention to provide a process for chemically “aging” reddish-brown tropical wood species, resulting in the wood product's immediately having the darkened color that otherwise would appear only after the passage of time.

Another object of the present invention is to provide a process which gives tropical woods a consistent, enriched, blended, natural color, which will not darken further.

Still another object of the present invention is to provide a process which is easy and inexpensive to perform in order to produce a quality wood product.

A further object of the present invention is to provide a process using a solution which reacts with natural oils and resins in the wood itself in order to produce a natural, stable color.

### BRIEF DESCRIPTION OF THE PREFERRED EMBODIMENT

The process of the present invention is designed for use with certain tropical wood species, all having natural reddish-brown color, which tends to darken over time. Such wood species include the following:

Hymenaea courbaril, also known commercially as Brazilian Cherry or Jatoba;

Myroxylon Balsamum, also known as Santos Mahogany;

Swietenia microphylia, also known as Honduras Mahogany;

Cedrela spp., also known as Spanish Cedar;

Manilkara bidentata, also known as Macaranduba;

Intsia biuga, also known as Merbau;

Koompassia Malaccans, also known as Kempas;

Eucalyptus marginata, also known as Jarrah; and

Carapa Guinness, also known as Andiroba.

The process is specifically directed to application on wood products intended for interior uses.

The present invention uses a solution of potassium dichromate (K₂Cr₂O₇) in an alcohol-based resin or isopropyl alcohol. The potassium dichromate is present in a concentration of 40 grams per liter of basis, or 300 fluid ounces per gallon of basis. Alcohol-based resins such as Akzo Nobel's resin, or Methoxy Propanol, Propoxy Propanol, or #N-Methyl Pyrrulidone, can be used. In solution, the potassium dichromate is a strong oxidizing agent having a minimum level of CrO₃ of 67%.

Before the chemical solution is applied, the surfaces of the wood product should be sanded in order to open the pores of the wood to allow for maximum penetration of the solution. The chemical solution is applied directly to the surface of the wood product by roller, spray, dipping, brushing, or any other means which can evenly distribute the solution. Because the solution has a volatile base, it is conducted to the interior of the wood fibers. The solution comes in contact with the natural oils and resins contained in the wood, such as lignin, which have high levels of refraction of photochemical and thermal origins. The resulting reduction-oxidation reaction causes the wood's color to change: the process accelerates and simulates the natural aging of the wood, which would ordinarily occur over time when the wood is exposed to ultraviolet rays and oxidizing agents. The darker reddish-brown color produced by the process of the present invention matches the naturally oxidized color of the specific wood species to which it is applied. The color is even, stable, and permanent.

After the chemical reaction has occurred, the wood product can be allowed to air dry or can be dried using conventional means. Optionally, a coating of ultraviolet acrylic can be applied to the surface of the wood in order to reduce fading, staining, wear, and microbial growth.

Although the chemical solution herein described constitutes a preferred embodiment of the invention, it is understood that the invention is not limited to this precise chemical solution, and that changes may be made therein without departing from the scope of this invention.

1. A process for chemically aging wood products having surfaces, the process comprising:
(a) sanding the surfaces of the wood products;
(b) applying to the surfaces of the wood products a high concentrate solution of potassium dichromate in a basis isopropyl alcohol;
(c) allowing sufficient time to pass for completion of a chemical reaction; and
(d) drying the wood product.

2. The process of claim 1 wherein the wood from which the wood products are formed is selected from the group of wood species consisting of Hymenaea courbaril, also known commercially as Brazilian Cherry or Jatoba; Myroxylon Balsamum, also known as Santos Mahogany; Swietenia microphylia, also known as Honduras Mahogany: Cedrela spp., also known as Spanish Cedar; Manilkara bidentata, also known as Macaranduba, Intsia biuga, also known as Merbau; Koompassia Malaccans, also known as Kempas; Eucalyptus marginata, also known as Jarrah; and Carapa Guinness, also known as Andiroba.

3. The process of claim 1 wherein the wood products are selected from the group consisting of flooring, paneling, molding, and furniture.

4. The process of claim 1 wherein the potassium dichromate is present in a concentration selected from the group consisting of 40 grams per liter of basis and 300 fluid ounces per gallon of basis.

5. The process of claim 1 wherein the solution is mixed with an additive selected from the group consisting of Methoxy Propanol, Propoxy Propanol, #N-Methyl Pyrrolidone, and a mixture of a water-based acrylic polymer and an aliphatic water-based urethane resin.

6. (canceled)

7. A process for chemically aging wood products made from certain tropical wood species having natural reddish-brown color and further having natural oils and resins, the process comprising the steps of:
(a) preparing a high concentrate solution of potassium dichromate in a basis isopropyl alcohol;
(b) causing the solution to come in contact with the natural oils and resins in the wood products;
(c) completing a chemical reaction between the solution and the natural oils and resins; and
(d) drying the wood products;
wherein the tropical wood species from which the wood products are formed is selected from the group consisting of Hymenaea courbaril, also known commercially as Brazilian Cherry or Jatoba; Myroxylon Balsamum, also known as Santos Mahogany; Swietenia microphylia, also known as Honduras Mahogany; Cedrela spp., also known as Spanish Cedar; Manilkara bidentata, also known as Macaranduba; Intsia biuga, also known as Merbau; Koompassia Malaccans, also known as Kempas; Eucalyptus marginata, also known as Jarrah; and Carapa Guinness, also known as Andiroba.

8. (canceled)

9. The process of claim 7 wherein the wood products are selected from the group consisting of flooring, paneling, molding, and furniture.

10. The process of claim 7 wherein the potassium dichromate is present in a concentration selected from the group consisting of 40 grams per liter of basis and 300 fluid ounces per gallon of basis.

11. The process of claim 7 wherein the solution is mixed with an additive selected from the group consisting of Methoxy Propanol, Propoxy Propanol, #N-Methyl Pyrrolidone, and a mixture of a water-based acrylic polymer and an aliphatic water-based urethane resin.

12. (canceled)

13. The process of claim 1 wherein the solution has a minimum level of CrO₃ of 67%

14. The process of claim 7 wherein the solution has a minimum level of CrO₃ of 67%
